(19) United States
(12) Patent Application Publication
(10) Pub. No.: US 2005/0111217 A1
(43) Pub. Date: May 26, 2005

(54) Color changing candle

(76) Inventor: Lee Xiao Feng, Shenzhen (CN)

Correspondence Address: CESARI AND MCKENNA, LLP, 88 BLACK FALCON AVENUE, BOSTON, MA, 02210, US

(21) Appl. No.: 10/869,001

(22) Filed: Jun. 16, 2004

(30) Foreign Application Priority Data
Nov. 25, 2003 (CN) 2003201151059

(51) Int. Cl. F23Q 2/32; F21L 19/00; F21V 35/00; F21V 33/00

(52) U.S. Cl. 362/161

(57) ABSTRACT

A color-changing candle is provided. The color-changing candle includes a fiber optic strand running adjacent and substantially parallel to the wick of the candle and interfaces with a photosensor. Light from the burning wick is transmitted via the fiber optic strand to the photosensor. When the photosensor is activated, a control unit illuminates one or more LEDs to change the color of the candle.

### RELATED APPLICATION

This application claims priority under 35 U.S.C. §119 to Patent Application Serial No. 2003201151059 filed Nov. 25, 2003 by Lee Xiao Feng in the People's Republic of China.

### FIELD OF THE INVENTION

The present invention relates to candles, and more particularly, to candles having novel decorative and ornamental features.

### BACKGROUND OF THE INVENTION

Candles have been employed for lighting, ceremonial and ornamental functions for generations. Candles typically are comprised of a combustible wick inserted into paraffin wax (or similar solid, combustible material) formed into an aesthetically pleasing shape, such as a cylinder, or into the shape of a molded figure. The wax may be appropriately colored by the use of the dyes resulting in a candle of any number of colors including a combination of colors such as stripes, swirls or mottled “tie-died” effects. However, candles generally remain fixed into the color of the dyes utilized when the candle is manufactured. It is desirous for candles to change color while in use to add to the aesthetic beauty and/or ornamental appeal of the candle.

### SUMMARY OF THE INVENTION

The present invention overcomes the disadvantages of the prior art by providing a color-changing candle that may assume different colors while being burnt. A fiber optic strand is embedded in the candle adjacent to and substantially parallel to the wick. The fiber optic strand interfaces with a photosensor and electronic circuitry embedded into the candle. While the wick is burning, light produced by the flame is transmitted via the fiber optic strand to the photosensor, which, in turn, activates the electronic circuitry to illuminate one or more light emitting diodes (LEDs) that generate a luminescent effect through the wax, and thereby cause the candle to change color according to the color(s) of the illuminated LED(s). The embedded electronic circuitry may illuminate the one or more LEDs in a pre-programmed pattern, resulting in a rotating or continuously changing color of the candle. Alternately, the electronic circuitry may activate a single LED to change the color of the candle between its natural state and the color of the LED. In an illustrative embodiment, the circuit includes a power supply, such as a battery, and appropriate logic to activate the LED(s) in a desired sequence.

### BRIEF DESCRIPTION OF THE DRAWINGS

The above and further advantages of the invention may be better understood by referring to the following description in conjunction with the accompanying drawings in which like-referenced numerals indicate identical or functionally similar elements:

FIG. 1 is cross-sectional side view of a color-changing candle in accordance with an embodiment of the present invention;

FIG. 2 is a schematic block diagram of exemplary electronic circuitry in accordance with an embodiment of the present invention; and

FIG. 3 is a cross-sectional side view of a multi-wick color-changing candle in accordance with an embodiment of the present invention.

### DETAILED DESCRIPTION OF AN ILLUSTRATIVE EMBODIMENT

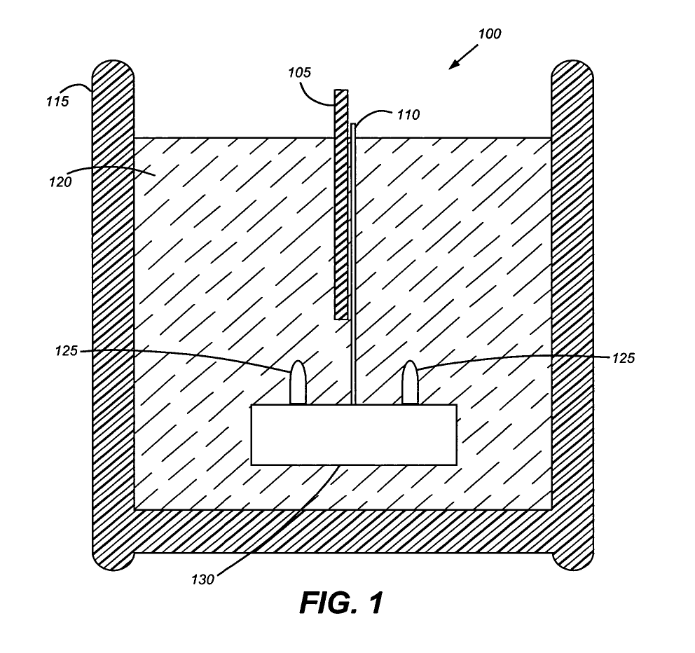

FIG. 1 is a cross-sectional schematic block diagram of an exemplary color-changing candle 100 in accordance with an illustrative embodiment of the present invention. The candle 100 comprises a wick 105 embedded within a body 120. The wick may be any appropriate size, and multiple wicks may be employed. Adjacent and substantially parallel to the wick 105 (or at least one of the plurality of wicks) is an optical line, such as a fiber optic strand 110 that leads to embedded electronic circuitry 130. The fiber optic strand is illustratively placed as close as possible to the wick, but may be placed at a spacing where desired. The electronic circuitry 130 includes one or more light emitting diodes (LEDs) 125. Surrounding the body 110 is a casing 115. The wick 105 is comprised of a combustible material as wicks are conventionally in the art. The body 120 comprises either synthetic or natural paraffin (wax) or another conventional material as typically used in the manufacture of candles. The casing 115, which may be excluded without departing from the teachings of the present invention, typically comprises a transparent or translucent material, such as glass, acrylic or plastic.

The fiber optic strand 110 is illustratively made of a material that melts when exposed to the heat generated by the flame. In one embodiment, a light transmissive plastic is used. The strand has a diameter in a range of approximately 0.5 mm to 1.5 mm in an illustrative embodiment. However, it is expressly contemplated that other light transmitting elements such as a hollow light-pipe may be employed. However, in alternate embodiments, the fiber optic strand may be made of a material that disintegrates or vaporizes in a differing manner in response to the localized heat generated by the flame. The fiber optic strand 110 collects light generated by the wick 105 while burning and channels the light to the electronic circuitry 130. In response to detecting the light channeled from the fiber optic strand 110, the electronic circuitry 130 activates the one or more LEDs 125, which cause the body 120 of the candle to change color in conformance with the color of the LED.

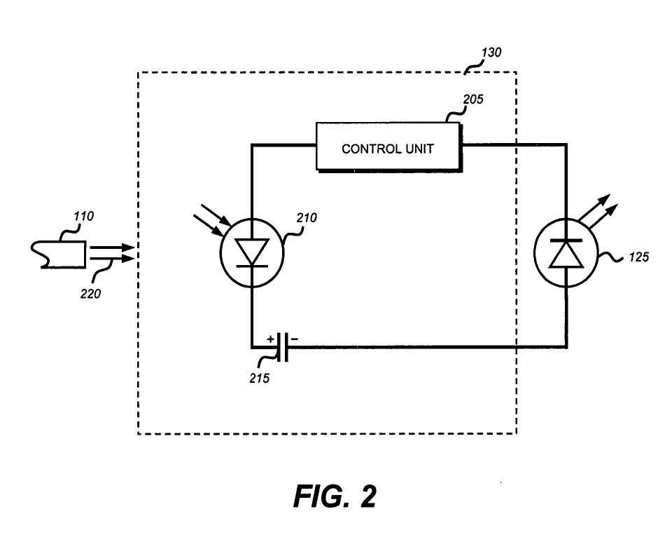

FIG. 2 is a schematic block diagram of the embedded electronic circuitry 130 in accordance with an illustrative embodiment of the present invention. The embedded electronic circuitry 130 comprises a control unit 205, a photosensor 210 and battery 215. In the illustrative embodiment, light 220 travelling via the fiber optic strand 110 activates the photosensor 210. The photosensor 210 may comprise a photo-diode, photo-transistor, photo-resistor or other conventional photo-detection device. The control unit 205 may comprise an embedded microcontroller and/or discrete components that activate one or more LEDs 125 in response to detection of light 220 by the photosensor 210. The battery 215 provides appropriate power to illuminate LEDs 125. In alternate embodiments the battery 215 may be replaced with another alternative power source, such as an adapter to enable the color-changing candle to be plugged into a conventional wall socket and powered by AC current directly or via a transformer.

The light emitting diodes 125 may comprise uni- or multi-color LEDs that, when illuminated, cause the body of the candle to exhibit the appropriate color. In an alternate embodiment, a light emitting device, other than LEDs, may be utilized, such as conventional electronic lamp.

In the illustrative embodiment, the control unit 205 cycles the one or more LEDs 125 on and off to effectuate a cyclic change to the color of the candle. In alternate embodiments, the control unit 205 activates the one or more LEDs 125 and does not cycle through various color combinations. As will be appreciated by one skilled in the art, the construction of the control unit 205 is dictated by the desires of the manufacturer to produce a particular pattern of colors from LEDs 125. The control unit 205 may be constructed to generate any desired sequence of colors from the one or more LEDs 125.

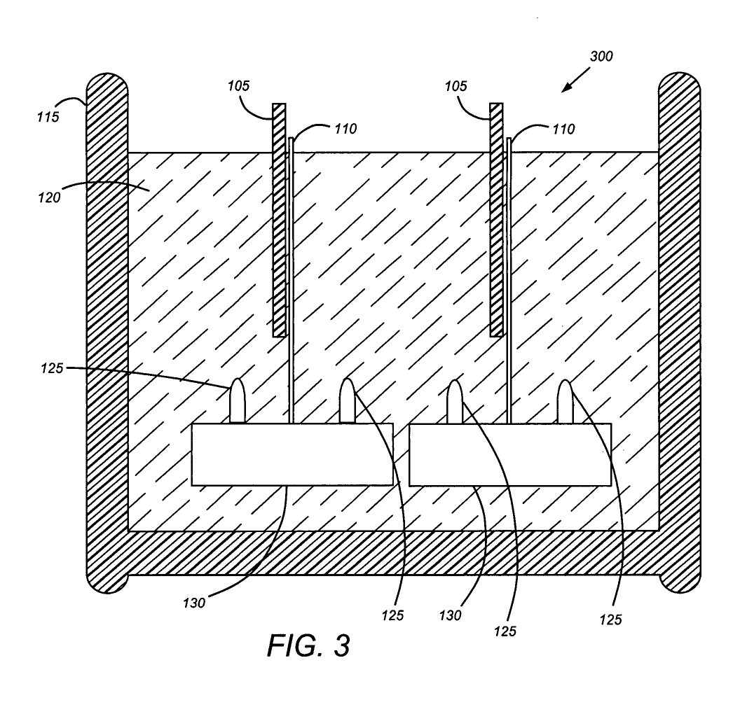

In alternate embodiments, the number of wicks and/or fiber optic strands may be varied. FIG. 3 is a cross-sectional view of an exemplary multi-wick color changing candle 300 in accordance with an embodiment of the present invention. The candle 300 includes a plurality of wicks 105, each of which is associated with a fiber optic strand 110 that directs light from a flame to a control circuit 130. It should be noted that while two wicks are shown in the exemplary figure, the principles of the present invention are not so limited and any number of wicks may be utilized in accordance with the teachings of the present invention. Such multi-wick embodiments may be utilized in large candles, wherein each LED 125 may be of a differing color to thereby enable to candle 300 to display a variety of colors simultaneously. In the exemplary FIG. 3, each fiber optic strand is operatively interconnected with a separate control circuit 130; however, in alternate embodiments, a plurality of fiber optic strands may be operatively interconnected with a single control circuit.

To again summarize, the present invention comprises a candle having a wick and a fiber optic strand adjacent and substantially parallel to the wick that interfaces with a photosensor that is operatively interconnected with a set of electronic circuitry adapted to control and illuminate one or more LEDs. While the wick is burning, light is transmitted via the fiber optic strand to the photosensor. This activates the photosensor and causes a control unit to illuminate one or more LEDs in a predefined sequence, thereby changing the color of the candle in conformity with the color of the illuminated LED.

The foregoing description has been directed to particular embodiments of this invention. It will be apparent, however, that other variations and/or modifications may be made to the described embodiments with the attainment of some or all of the their advantages and that this description should be taken only by way of example. For example, while a particular electronic circuit is shown and described, a variety of circuits using analog, digital or a combination of components can be employed. Furthermore, multiple fiber optic strands may be employed so that, for example, a plurality of fiber optic strands is associated with each wick of the candle. Additionally, while in the illustrative embodiment, the fiber optic strand is adjacent and substantially parallel to the wick, in alternate embodiments, the fiber optic strand may be inserted into the wick so that the wick encases the fiber optic strand. The teachings of this circuit and others contemplated herein can also be employed using software operating on an appropriate processor. It should be noted that other light emitting devices, other than conventional LEDs, may be utilized with the teaching of the present invention.

1. A color-changing candle comprising:
a body having a wick longitudinally inserted therein;
a fiber optic strand running adjacent and substantially parallel to the wick, the fiber optic strand interfacing with a photosensor; and
one or more light-emitting devices embedded in the body so as to transmit light therethrough and operable to illuminate in response to detected light from the photosensor.

2. The color-changing candle of claim 1 wherein the one or more light emitting devices comprise light emitting diodes.

3. The color-changing candle of claim 2 wherein each of the one or more light emitting devices is of a differing color.

3. The color-changing candle of claim 1 further comprising a control unit operatively interconnected with the photosensor and the one or more light emitting devices and adapted to illuminate the one or more light emitting devises in a predefined sequence.

4. The color-changing candle of claim 1 wherein the photosensor comprises a photo-transistor.

5. The color-changing candle of claim 1 wherein the photosensor comprises a photo-diode.

6. A color-changing candle comprising:
a body having a wick longitudinally inserted therein;
means for transmitting light from the wick to a means for sensing light; and
means for producing colored light operable to illuminate in response to detected light from the means for sensing light.

7. A color-changing candle comprising:
a body having a plurality of wicks longitudinally inserted therein;
a fiber optic strand running adjacent and substantially parallel to each of the wicks, the fiber optic strands each interfacing with a photosensor; and
one or more light-emitting devices embedded in the body so as to transmit light therethrough and operable to illuminate in response to detected light from any of the photosensors.

8. The color-changing candle of claim 7 wherein the one or more light emitting devices comprise light emitting diodes.

9. The color-changing candle of claim 8 wherein each of the one or more light emitting devices is of a differing color.

10. The color-changing candle of claim 7 further comprising one or more control units operatively interconnected with each of the photosensors and with one or more of the one or more light emitting devices and adapted to illuminate the one or more light emitting devises in a predefined sequence.

11. The color-changing candle of claim 7 wherein the photosensors comprise phototransistors.

15. The color-changing candle of claim 7 wherein the photosensors comprise photodiodes.
